(19) United States
(12) Patent Application Publication
(10) Pub. No.: US 2026/0168629 A1
(43) Pub. Date: Jun. 18, 2026

(54) REFILL STAND FOR SUPPORTING A FUEL SUPPLY TANK

(71) Applicant: YSN Imports, LLC, Commerce, CA (US)

(72) Inventors: Shmuel Dovid Newman, Los Angeles, CA (US); Jeffrey O. Brown, North Logan, UT (US)

(21) Appl. No.: 19/127,108

(22) PCT Filed: Jan. 3, 2024
(86) PCT No.: PCT/US2024/010225

§ 371 Date: May 3, 2025

Related U.S. Application Data
(60) Provisional application No. 63/422,891, filed on Nov. 4, 2022.

(51) Int. Cl. F17C 13/08

(52) U.S. Cl. CPC F17C 13/084; F17C 2201/0109; F17C 2201/035; F17C 2201/058; F17C 2205/018; F17C 2205/0329; F17C 2221/035; F17C 2270/0745

(57) ABSTRACT

A refill stand for supporting a fuel supply tank includes a hub element and multiple leg elements. The hub element has a plurality of leg receptacles in a first end. Each leg element extends from a hub engagement end to a tank engagement end, and includes a hub mount segment, a tank support segment and an intermediate segment disposed therebetween. Each hub mount segment is receivable in mounted engagement by a respective leg receptacle. A first angle is defined between the intermediate segment and the hub mount segment, and a second angle is defined between the intermediate segment and the tank support segment. The first and second angles may be less than 90 degrees. The tank support segment is longer than the hub mount segment. The tank engagement end is laterally offset from the hub engagement end, and vertically offset from the hub engagement end.

### RELATED APPLICATIONS

This application claims the benefit of U.S. Provisional Application No. 63/422,891 filed Nov. 4, 2022, the content of which is incorporated by this reference in its entirety for all purposes as if fully set forth herein.

### TECHNICAL FIELD

The present disclosure relates to support stands for fuel supply tanks, such as propane tanks.

### SUMMARY

Certain deficiencies of the prior art are overcome by the provision of a refill stand for supporting a fuel supply tank, as disclosed herein.

### BRIEF DESCRIPTION OF THE DRAWINGS

Further advantages of the present invention may become apparent to those skilled in the art with the benefit of the following detailed description of the preferred embodiments and upon reference to the accompanying drawings in which:

FIG. 1 is a diagrammatic perspective view of one non-limiting example of a refill stand for supporting a fuel supply tank;

FIG. 2 is a further diagrammatic perspective view of the example refill stand of FIG. 1;

FIG. 3 is a diagrammatic exploded view of the example refill stand of FIG. 1;

FIG. 4 is a diagrammatic front view of the example refill stand of FIG. 1;

FIG. 5 is a diagrammatic side view of the example refill stand of FIG. 1;

FIG. 6 is a diagrammatic top view of the example refill stand of FIG. 1;

FIG. 7 is a diagrammatic bottom view of the example refill stand of FIG. 1;

FIG. 8 is a diagrammatic partial view of an example leg element, wherein the hub engagement segment has an oblong cross-section;

FIG. 9 is a diagrammatic bottom view of an example hub element, wherein each leg receptacle has an elongated cross-section;

FIG. 10 is a diagrammatic partial perspective view of an example refill stand, wherein hub engagement segments similar to those shown in FIG. 8 are in mounted engagement with the leg receptacles similar to those shown in FIG. 9;

FIG. 11 is a diagrammatic side view of an example propane refill system including an example refill stand, supported fuel supply tank, application fuel canister and quick-fill apparatus;

FIG. 12 is a diagrammatic perspective view of the example propane refill system of FIG. 11;

FIG. 13 is a further diagrammatic perspective view of the example propane refill system of FIG. 11;

FIG. 14 is a diagrammatic exploded view of an alternate example refill stand, wherein the hub engagement portions of the leg elements include detent interface portions configured to restrict rotation of the leg elements with respect to the hub element;

FIG. 15 is a diagrammatic cross-sectional view of an example leg element;

FIG. 16 is a diagrammatic top view of the alternate example refill stand of FIG. 14;

FIG. 17 is a diagrammatic cross-sectional view taken across lines 17-17 in FIG. 16;

FIG. 18 is a diagrammatic side view of the alternate example refill stand of FIG. 14;

FIG. 19 is a diagrammatic cross-sectional view taken across lines 19-19 in FIG. 118;

FIG. 20 is a diagrammatic perspective view of one example hub element, wherein the leg receptacles include rotation detents;

FIG. 21 is a further diagrammatic perspective view of the example hub element of FIG. 20;

FIG. 22 is a diagrammatic bottom view of the example hub element of FIG. 20;

FIG. 23 is a diagrammatic top view of the example hub element of FIG. 20;

FIG. 24 is a diagrammatic cross-sectional view taken across lines 24-24 in FIG. 22;

FIG. 25 is a diagrammatic cross-sectional view taken across lines 25-25 in FIG. 23

FIG. 26 is a diagrammatic perspective view of an example foot element;

FIG. 27 is a diagrammatic cross-sectional view of the example foot element of FIG. 26 and associated intermediate segment of a leg element, prior to the foot element being attached to the intermediate segment;

FIG. 28 is a diagrammatic cross-sectional view similar to that of FIG/. 27, but wherein the foot element is shown removably attached to the intermediate segment of a respective leg element;

FIG. 29 is a diagrammatic partial side view of an example leg element, showing a foot element attached thereto;

FIG. 30 is a diagrammatic top view of an example refill stand kit in a packaging configuration, including an application canister and quick-fill apparatus;

FIG. 31 is a diagrammatic side view of the example refill stand kit of FIG. 30; and

FIG. 32 is a diagrammatic perspective view of the example refill stand kit of FIG. 30.

### DETAILED DESCRIPTION OF THE PREFERRED EMBODIMENTS

Referring now to the drawings, like reference numerals designate identical or corresponding features throughout the several views.

Certain example embodiments of a refill stand for supporting a fuel supply tank are shown generally at 100.

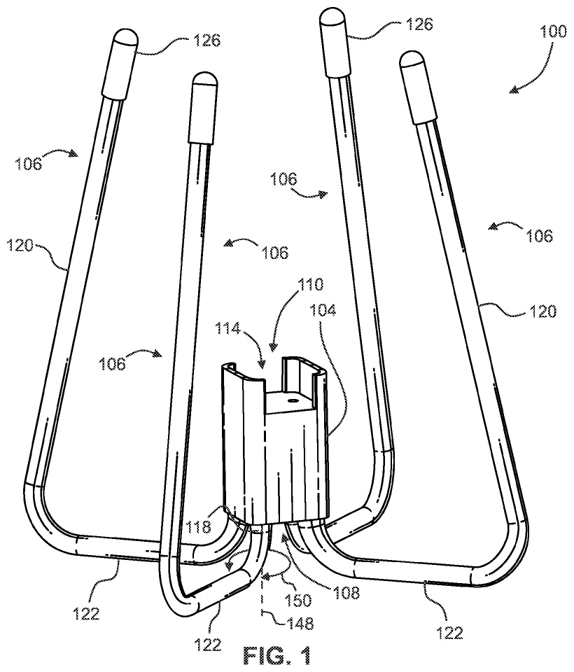

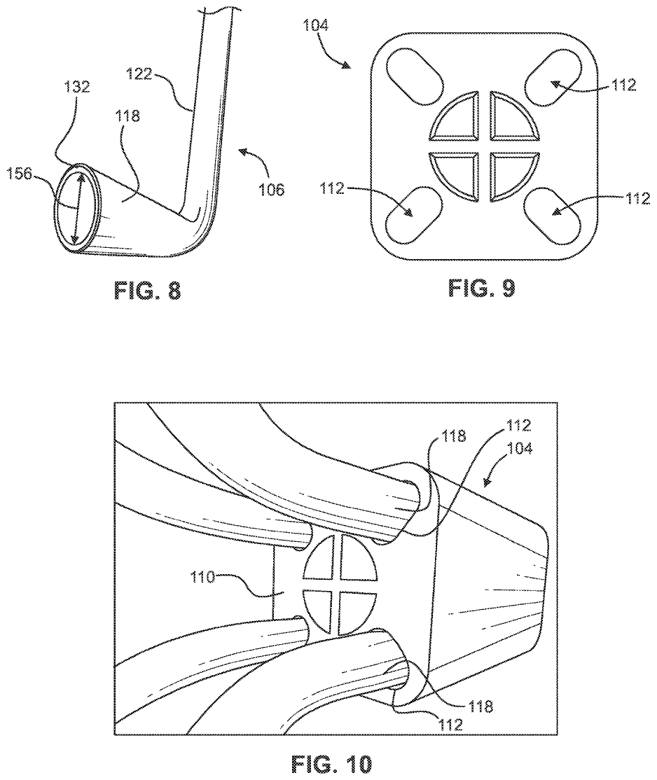

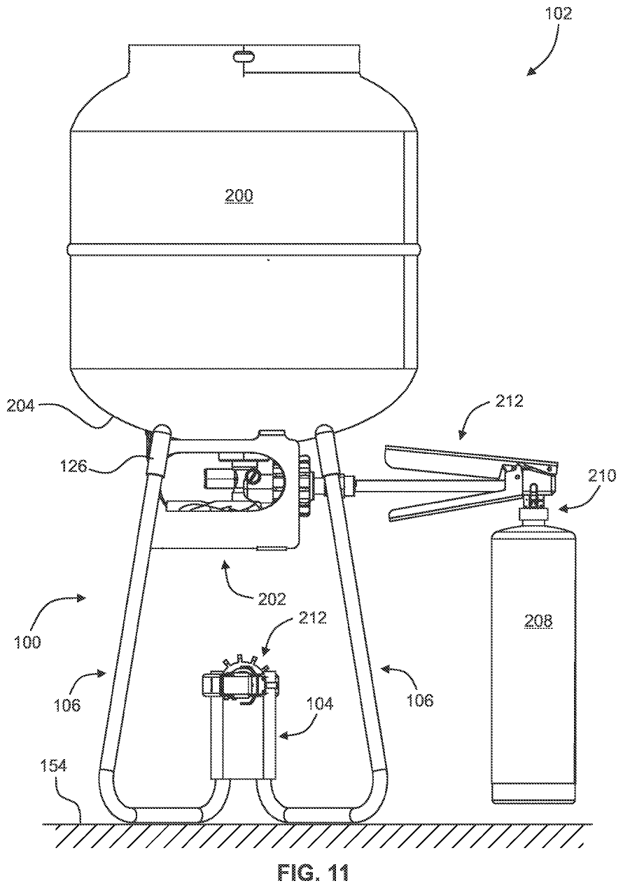

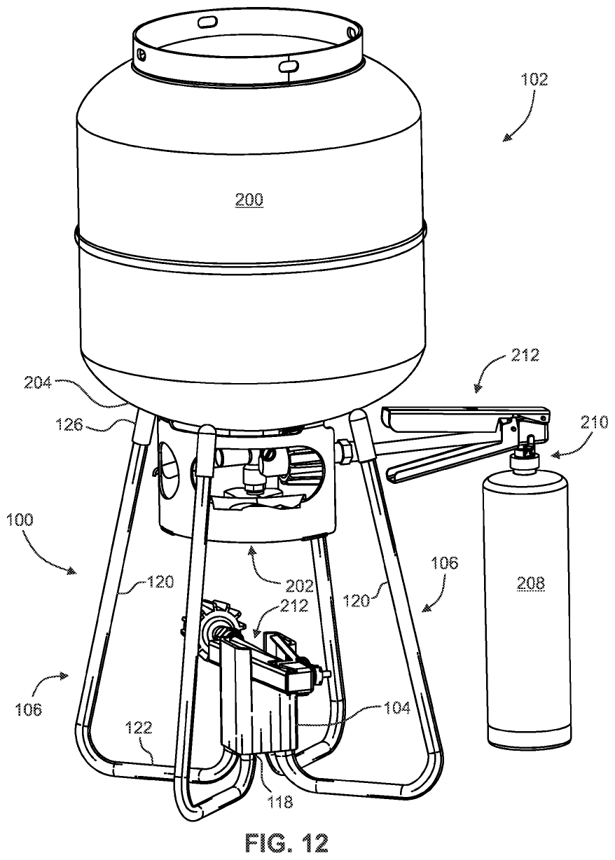

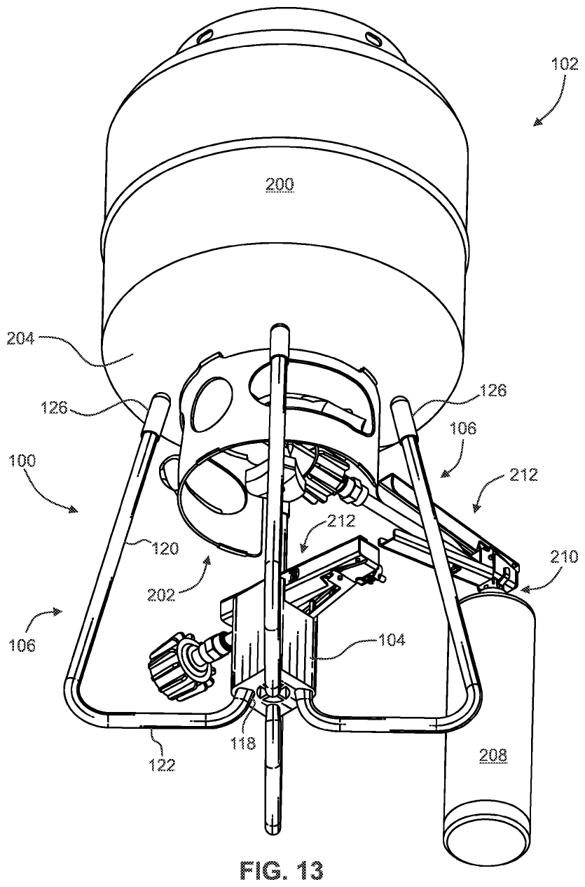

Referring to FIG. 1, a refill stand 100 may comprise a hub element 104 and a multiplicity of leg elements 106. The multiplicity may be, for example, three or four said leg elements 106. Referring to FIGS. 11-13, the refill stand 100 may be configured to support a fuel supply tank 200 (e.g., an inverted 20-lb propane tank or the like), thereby allowing the fuel supply tank 200 to be used to fill an application fuel canister (e.g., a 1-lb fuel canister) by way of, for example, a quick-fill apparatus 212.

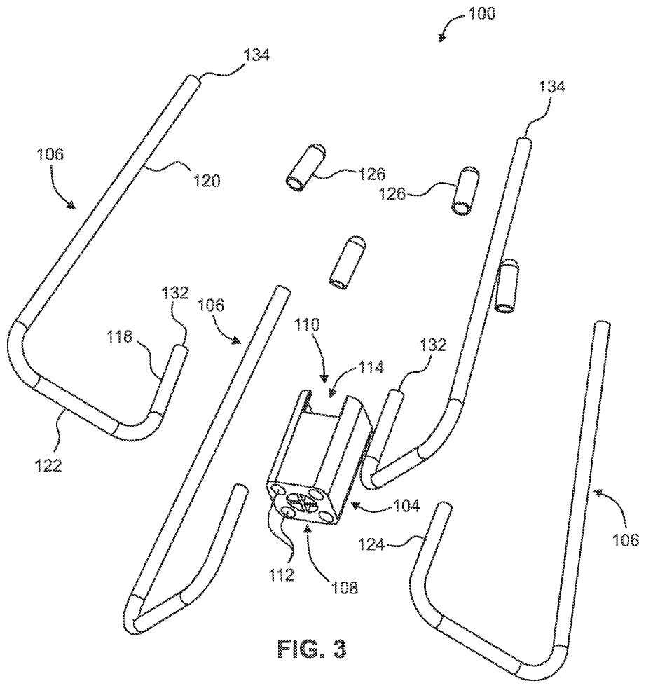

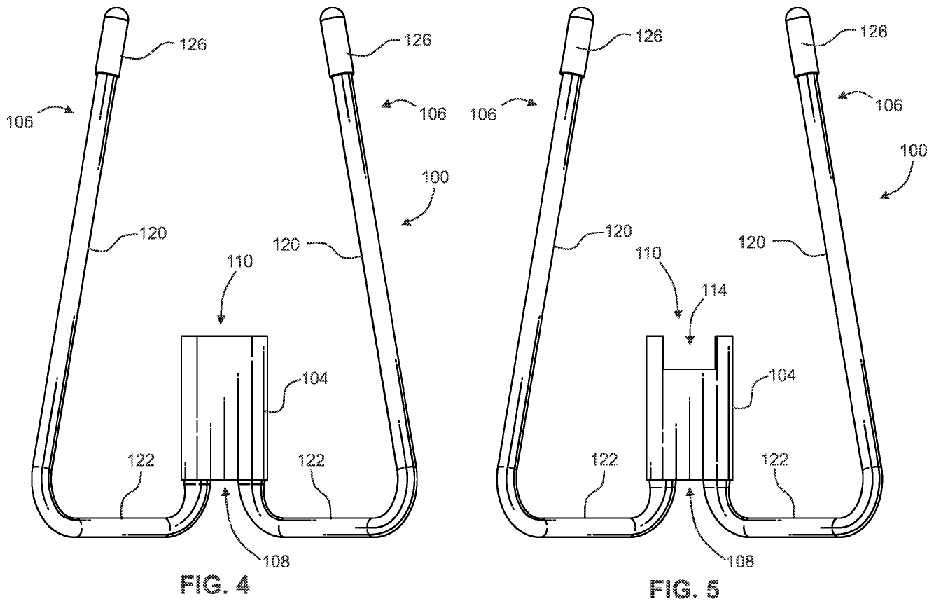

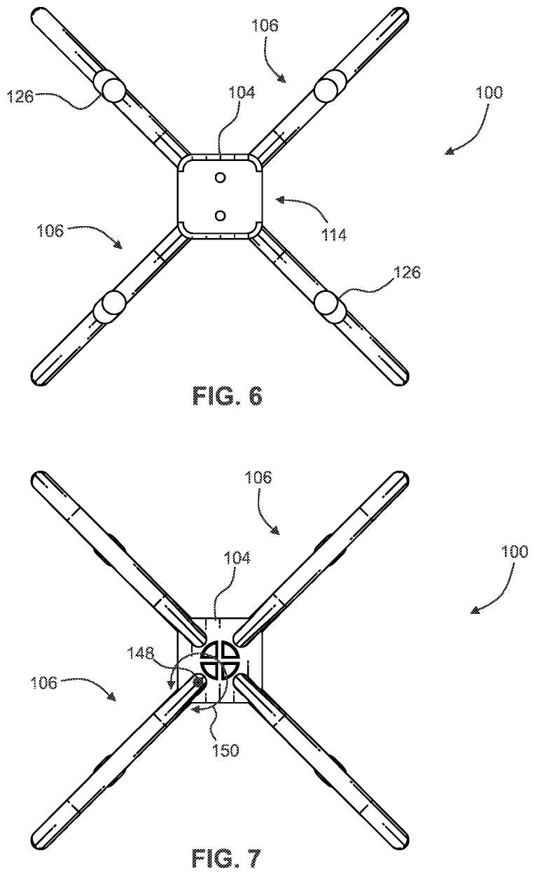

Referring to FIGS. 3, 9 and 20, a hub element 104 may have a first end 108 and a second end 110. The second end 110 is disposed oppositely of the first end 108. The hub element 104 may include a plurality of leg receptacles 112 in the first end 108. Referring to FIG. 1, and 11-13, in certain embodiments of a refill stand 100, the hub element 104 may include an auxiliary retention portion 114 configured to aligningly support a quick fill apparatus 212. The auxiliary retention portion 114 may preferably be formed at the second end 110 of the hub element 104, and may preferably be in the form of a groove configured to receive the quick-fill apparatus 212, and vertically support and laterally confine the quick-fill apparatus 212 on the hub element 104.

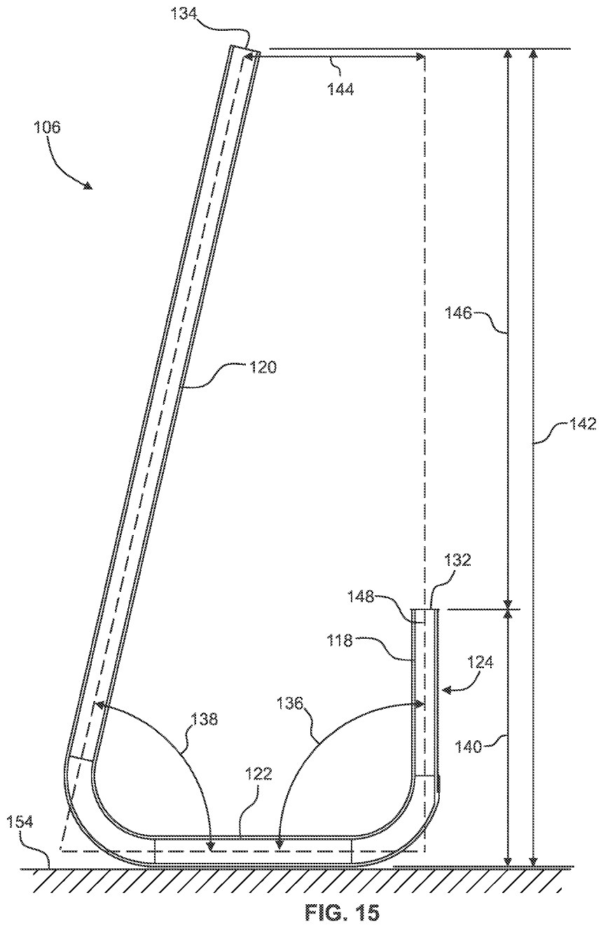

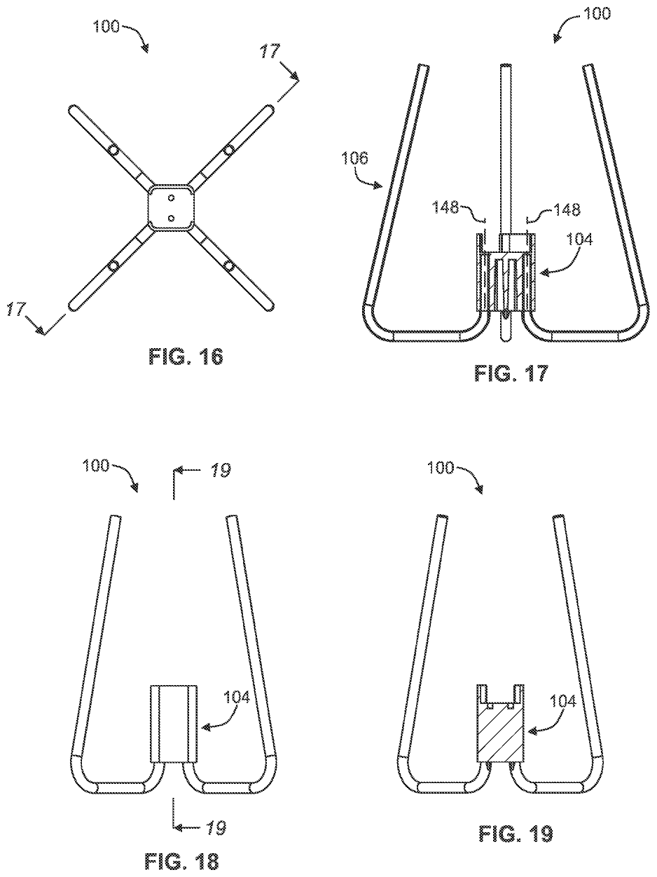

Referring to FIGS. 3 and 15, each leg element 106 may extending from a hub engagement end 132 to a tank engagement end 134. Each leg element 106 may preferably include a hub mount segment 118, a tank support segment 120 and an intermediate segment 122 disposed therebetween. Referring to FIGS. 8-10, the hub mount segment 118 may be configured to be received in a mounted engagement by a respective leg receptacle 112.

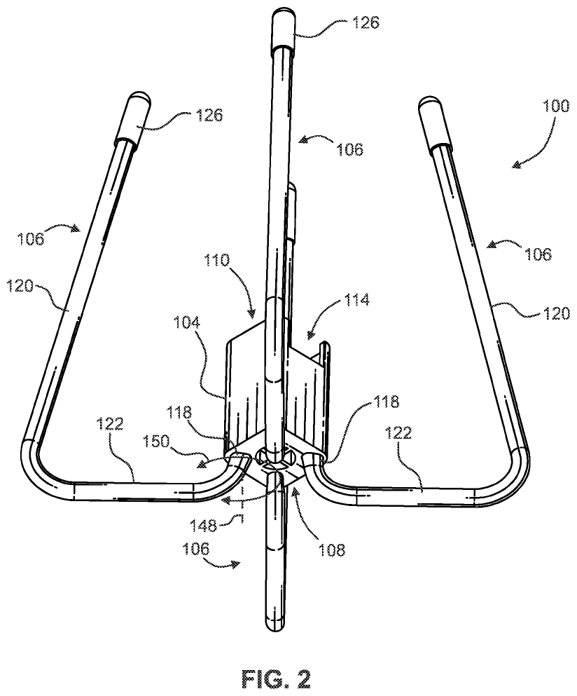

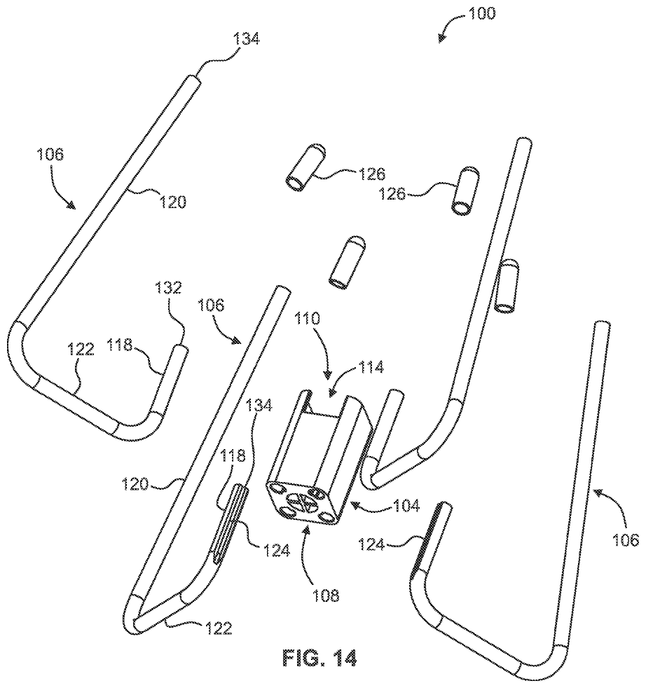

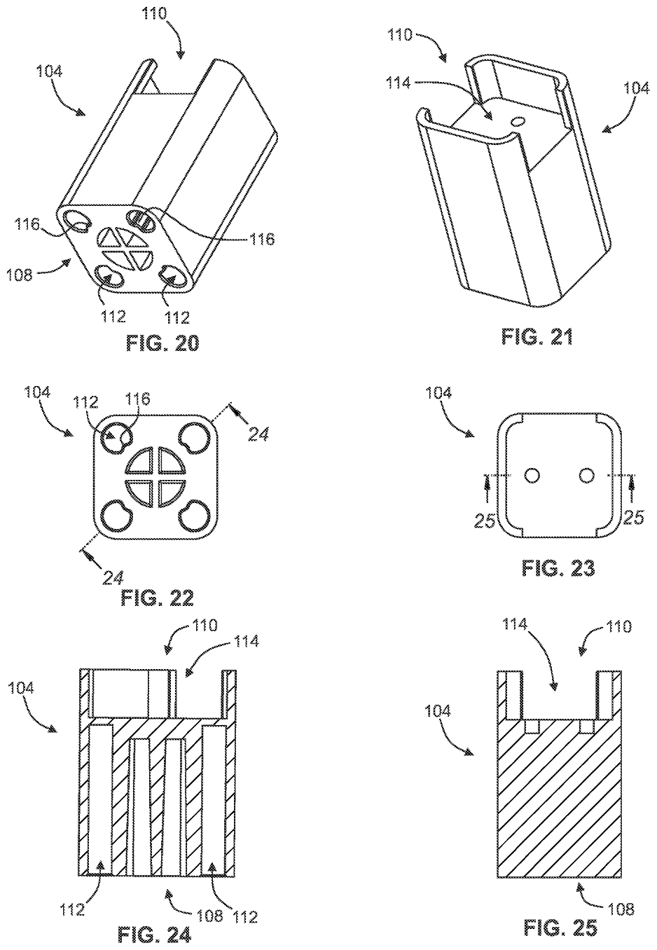

Referring to FIGS. 1, 2 and 7, in certain preferred embodiments of a refill stand 100, the mounted engagement (a) is along a hub engagement axis 148 which is parallel to the hub mount segment 118; and (b) restricts rotatability of the respective leg segment 106 with respect to the hub element 104 about the hub engagement axis 148 (e.g., in rotation direction 150). More particularly, referring to FIGS. 8-10, each of the hub mount segments 118 may have an oblong cross-section (e.g., in elongation direction 156) which facilitates the restriction of the rotatability. Additionally or in the alternative, referring to FIGS. 14 and 20, each of the hub mount segments 118 may include a detent interface portion 124. Correspondingly, each of the leg receptacles 112 may include a rotation detent 116, wherein the detent interface portions 124 are configured to engage a respective rotation detent 116 when the hub mount segment 118 is in the mounted engagement.

Referring to FIG. 15, in particular examples of a refill stand 100, a first angle 136 is defined between the intermediate segment 122 and the hub mount segment 118. Similarly, in certain examples of a refill stand 100, a second angle 138 is defined between the intermediate segment 122 and the tank support segment 120. The first angle may preferably be 90 degrees. The second angle may preferably be less than 90 degrees (e.g., 60-80 degrees).

Referring again to FIG. 15, in certain example leg elements 106, the tank support segment 120 is longer than the hub mount segment 118. For example, the tank support segment 120 may be two times (or greater than two times) the length of the hub mount segment 118. Alternatively or in addition, the tank engagement end 134 may be (a) laterally offset from the hub engagement end 132 (e.g., as shown by laterally offset 144), and/or (b) vertically offset from the hub engagement end 132 (e.g., as shown by vertical offset 146).

Referring to FIGS. 1 and 3, in particular examples of a refill stand 100, each leg element 106 may include a tank interface cap 134 installed on the tank engagement end 134. The tank interface caps 134 may preferably be comprised of a polymer.

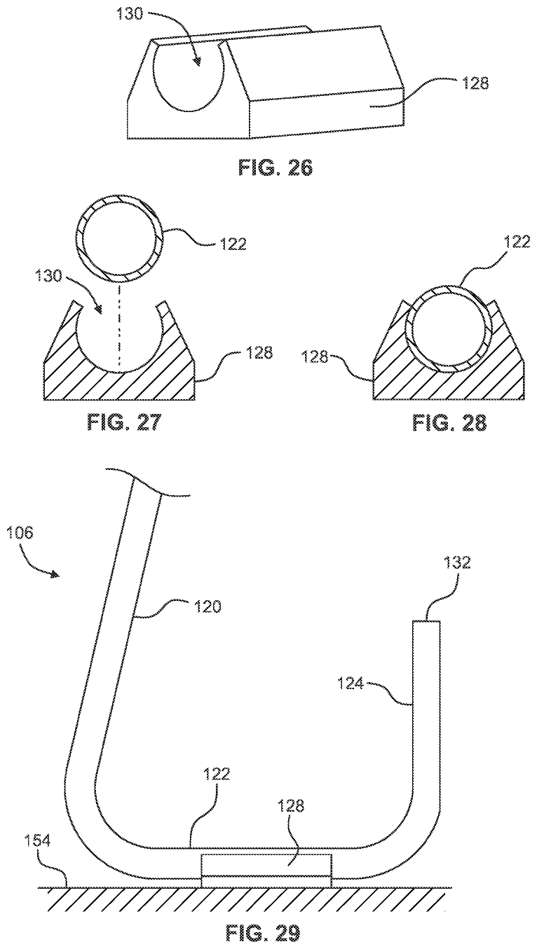

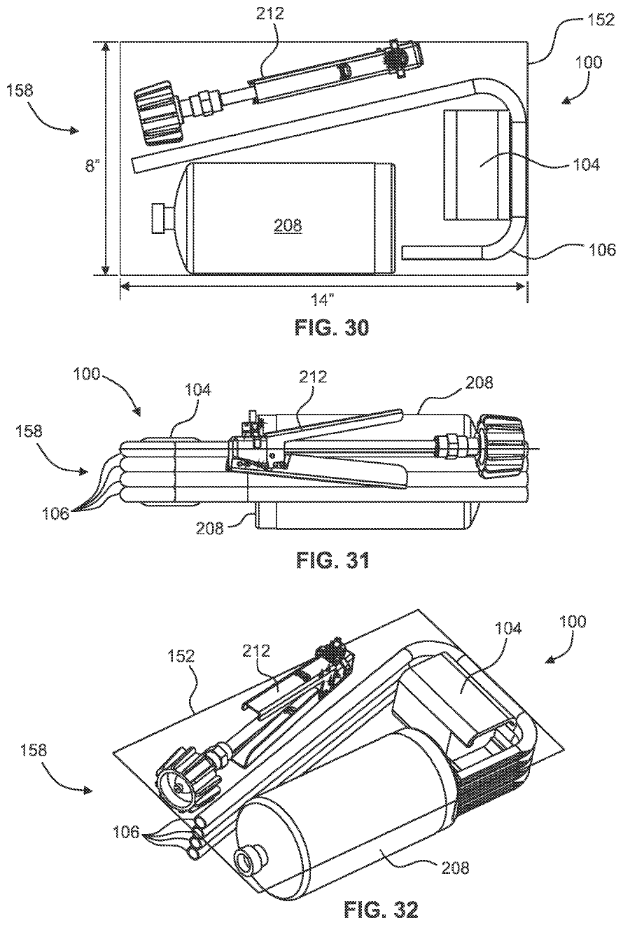

Referring to FIGS. 26-29, the refill stand 100 may further comprise a plurality of foot elements 128. Each foot element may be removably attachable to the intermediate segment 122 of a respective said leg element 106. For example, the foot elements 128 may be comprised of a polymer and may include a leg attachment receptacle 130 for grippingly receiving a portion for the intermediate segment 122. Thus, the foot elements 128 may be removably manually snap-fit or press-fit onto the intermediate segment 122 of the leg element 106.

The following listing matches certain terminology used within this disclosure with corresponding reference numbers used in the non-limiting examples illustrated in the several figures.
100 Refill Stand
102 refill system
104 hub element
106 leg element
108 first end (of hub element)
110 second end (of hub element)
112 leg receptacles
114 auxiliary retention portion (e.g., stowage slot for quick-fill apparatus)
116 rotation detent
118 hub mount segment
120 tank support segment
122 intermediate segment
124 detent interface portion
126 tank interface cap
128 foot element (e.g., press-fit or snap-fit)
130 leg engagement receptacle (aspect of foot element)
132 hub engagement end (of leg element)
134 tank engagement end (of leg element)
136 first angle
138 second angle
140 first height
142 second height
144 lateral offset (between hub engagement end and tank engagement end)
146 vertical offset
148 hub engagement axis
150 rotational direction (about hub engagement axis)
152 projected packaging lateral boundary
154 support substrate (e.g., ground, floor, etc.)
156 elongated direction (of cross section of hub mount segment)
158 refill stand kit packaging configuration
200 fuel supply tank (e.g., conventional 20 lb propane tank)
202 handle portion
204 supported surface
206 supply tank valve assembly
208 application fuel canister (e.g., 1 lb propane bottle)
210 canister valve
212 quick-fill apparatus

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A refill stand for supporting a fuel supply tank, the refill stand comprising:
a hub element having a first end and a second end, the second end being disposed oppositely of the first end, the hub element including a plurality of leg receptacles in the first end; and
a multiplicity of leg elements, each leg element extending from a hub engagement end to a tank engagement end;
wherein
(a) each leg element includes a hub mount segment, a tank support segment and an intermediate segment disposed therebetween,
(b) the hub mount segment being configured to be received in a mounted engagement by a respective said leg receptacle.

2. The refill stand as defined in claim 1, wherein a first angle is defined between the intermediate segment and the hub mount segment.

3. The refill stand as defined in claim 2, wherein a second angle is defined between the intermediate segment and the tank support segment.

4. The refill stand as defined in claim 3, wherein the second angle is less than 90 degrees.

5. The refill stand as defined in claim 4, wherein the first angle is 90 degrees.

6. The refill stand as defined in claim 1, wherein the tank support segment is longer than the hub mount segment.

7. The refill stand as defined in claim 1, wherein the tank engagement end is
(a) laterally offset from the hub engagement end; and
(b) vertically offset from the hub engagement end.

8. The refill stand as defined in claim 1 comprising four said leg elements.

9. The refill stand as defined in claim 1, wherein each said leg element includes a tank interface cap installed on the tank engagement end, the tank interface caps being comprised of a polymer.

10. The refill stand as defined in claim 1, wherein the mounted engagement
(a) is along a hub engagement axis which is parallel to the hub mount segment; and
(b) restricts rotatability of the respective leg segment with respect to the hub element about the hub engagement axis.

11. The refill stand as defined in claim 10, wherein each of the hub mount segments has an oblong cross-section which facilitates the restriction of the rotatability.

12. The refill stand as defined in claim 10, wherein
(a) each of the hub mount segments includes a detent interface portion;
(b) each of the leg receptacles includes a rotation detent; and
(c) the detent interface portions are configured to engage a respective said rotation detent when the hub mount segment is in the mounted engagement.

13. The refill stand as defined in claim 1, wherein the hub element includes an auxiliary retention portion configured to aligning support a quick fill apparatus.

14. The refill stand as defined in claim 1, further including a plurality of foot elements, each foot element being removably attachable to the intermediate segment of a respective said leg element.
